(19) United States
(12) Patent Application Publication
(10) Pub. No.: US 2015/0257335 A1
(43) Pub. Date: Sep. 17, 2015

(54) Self-Cleaning Rake

(71) Applicants: Donald Riggs, Morgantown, WV (US); Cristina Riggs, Morgantown, WV (US)

(72) Inventors: Donald Riggs, Morgantown, WV (US); Cristina Riggs, Morgantown, WV (US)

(21) Appl. No.: 14/550,497

(22) Filed: Nov. 21, 2014

Related U.S. Application Data
(60) Provisional application No. 61/952,253, filed on Mar. 13, 2014.

(51) Int. Cl. A01D 7/10

(52) U.S. Cl. CPC A01D 7/10

(57) ABSTRACT

Disclosed is a self-cleaning rake. The rake includes an elongated shaft having a rake head on one end thereof. The rake head includes a plurality of elongated tines that can be used to rake leaves and other debris. A cleaning bar is slidably disposed on the tines and can be moved from the first end of the tines towards the second end in order to remove debris lodged between the tines. An extension rod is secured at a first end to the cleaning bar and extends through the rake head and into the interior of the elongated shaft of the self-cleaning rake. A grip is slidably positioned on the exterior of the shaft and is operably connected to the extension rod, such that moving the grip moves the cleaning bar along the tines. The extension rod may be spring-loaded so that the extension rod automatically retracts when extended.

### CROSS REFERENCE TO RELATED APPLICATION

This application claims the benefit of U.S. Provisional Application No. 61/952,253 filed on Mar. 13, 2014. The above identified patent application is herein incorporated by reference in its entirety to provide continuity of disclosure.

### BACKGROUND OF THE INVENTION

1. Field of the Invention

The present invention relates to a self-cleaning rake adapted to remove leaves and debris from the tines thereof. More specifically, the present invention provides a rake having an elongated shaft and a rake head having a plurality of tines thereon, wherein a cleaning bar is disposed on the tines and can be moved along the tines in order to remove debris thereon. The cleaning bar can be moved along the tines by actuating a grip disposed on the shaft of the rake and operably connected to the cleaning bar by means of an extension rod disposed within the elongated shaft.

Leaves and other debris often gather in yards, lawns, and other areas. This is particularly true during autumn when the leaves on trees fall to the ground throughout the season. Such debris must be collected and removed in order to maintain the property and the appearance thereof.

Rakes are often used to collect leaves and other debris accumulated on a lawn or other area. Raking can be a time consuming and laborious process as the user must continually sweep leaves into a pile. While raking, leaves and debris may become stuck between the tines of the rake, preventing the rake from functioning in the usual manner. As a result, the user must stop raking and remove the debris by hand. This can be a messy process and slows the already difficult task of raking leaves.

The present invention provides a self-cleaning rake. The rake comprises an elongated shaft having a first end adapted to be held by a user, and a second end having a rake head thereon. The rake head includes a plurality of tines extending therefrom and arranged parallel to one another. A cleaning bar is slidably attached to the tines and is orthogonal thereto. The cleaning bar can be moved from the first end of the tines towards the second end thereof to remove debris stuck between the tines. An extension rod is secured to the cleaning bar and extends through the rake head and into the elongated shaft of the self-cleaning rake. A grip is slidably disposed on the elongated shaft and is operably connected to the extension rod. In this way, a user can actuate the cleaning bar on the tines by moving the grip towards or away from the rake head. Further, the extension rod may be spring-loaded such that the grip and the extension rod automatically retract to a resting position after being extended.

2. Description of the Prior Art

Devices have been disclosed in the prior art that relate to self-cleaning rakes. These include devices that have been patented and published in patent application publications. These devices generally relate to rakes having attachments used to dislodge debris stuck between the rake tines. The following is a list of devices deemed most relevant to the present disclosure, which are herein described for the purposes of highlighting and differentiating the unique aspects of the present invention, and further highlighting the drawbacks existing in the prior art.

One such device, U.S. Pat. No. 6,851,254 to Dalfors discloses a self-cleaning rake. The rake comprises a handle and a rake head having a plurality of tines thereon. A cleaning bar having a plurality of cleaning channels can be actuated by a push-rod. Each cleaning channel corresponds to the shape of one of the tines on the rake, and when the push-rod is actuated the cleaning bar moves along the tines so as to remove debris therefrom. While Dalfors discloses a self-cleaning rake, the device of Dalfors does not include a cleaning bar disposed orthogonally to the rake tines that slides along the length thereof when a grip disposed on the shaft of the rake is actuated.

U.S. Pat. No. 4,776,158 to Baum discloses a self-cleaning rake comprising a bar on the teeth of the rake that is movable via a push rod arranged on the handle of the rake. The push rod is used to move the bar from a raised position for raking, and a lowered position for leaf removal. A spring clip holds the bar in the raised position. Thus, Baum discloses a self-cleaning rake having a push bar located on the exterior of the rake handle, and having a separate grip thereon for actuating the push bar. This arrangement is inconvenient as the user must take his or her hand off of the rake handle and instead grab the handle for the push bar in order to remove debris from the rake.

U.S. Pat. No. 5,713,193 to Stapley et al. discloses a self-cleaning rake comprising a handle and two sets of tines. The handle includes telescoping sections, wherein one section includes a cleaning bar attached to one set of tines. The cleaning bar also includes apertures through which a second set of tines extend. Thus, Stapley discloses a device with two sets of tines that move relative to one another to remove debris, and fails to disclose a set of tines having a cleaning bar thereon that can be moved along the length of the tines in order to dislodge debris thereon.

U.S. Pat. No. 5,501,069 to Lentz discloses a self-cleaning rake having a hand operated actuator that causes a spreader to slide along the rake tines in order to remove the debris therefrom. The tines pivot inside of a flange so as to move radially, as the spreader moves along the tines. Thus, Lentz discloses a rake having tines that extend outward from a fixed point. In contrast, the present invention comprises a self-cleaning rake having a cleaning bar that can be moved from the first end of a plurality of elongated, parallel tines towards the second end in order to remove debris lodged between the tines.

U.S. Design Pat. No. D329177 to Nace et al. discloses an ornamental design for a lawn rake. The lawn rake includes a cleaning device thereon that moves along the length of the tines. The handle of the lawn rake includes a grip thereon. While Nace discloses the design for a self-cleaning rake, Nace fails to disclose a rake having an extension rod that is spring-loaded, and does not disclose an extension rod enclosed within the rake head.

Finally, U.S. Pat. No. 941,292 to Wieman discloses a self-cleaning rake. The rake includes a plurality of curved teeth having a cleaner plate adapted to be moved over the teeth in order to remove leaves and debris therefrom. A sliding sleeve is mounted on the handle and is used to actuate the cleaner plate. The cleaner plate pivots along the teeth in order to remove debris. Thus, Wieman fails to disclose a rake having a cleaning element that is parallel to the rake head and moves along the length of the tines in order to remove debris therefrom. Instead, Wieman discloses a cleaner that pivots about the rake head.

These prior art devices have several known drawbacks. Devices in the prior art relate to self-cleaning rakes having various mechanisms for freeing debris from the rake tines. However, these devices do not include a grip disposed on the handle of the rake that can be easily actuated in order to move a cleaning bar disposed on the tines. Further, the present invention comprises a spring-loaded extension rod attached to the cleaning bar that causes the cleaning bar to return to a resting position after being extended. Thus, the present invention allows a user to easily remove debris from the tines of the rake without having to remove the debris by hand, or by using a secondary tool or device.

In light of the devices disclosed in the prior art, it is submitted that the present invention substantially diverges in design elements from the prior art and consequently it is clear that there is a need in the art for an improvement to existing self-cleaning rake devices. In this regard the instant invention substantially fulfills these needs.

### SUMMARY OF THE INVENTION

In view of the foregoing disadvantages inherent in the known types of self-cleaning rakes now present in the prior art, the present invention provides a new self-cleaning rake wherein the same can be utilized for providing convenience for the user when raking leaves and debris and removing such debris from the rake tines.

It is therefore an object of the present invention to provide a new and improved self-cleaning rake device that has all of the advantages of the prior art and none of the disadvantages.

It is another object of the present invention to provide a self-cleaning rake device that functions as a conventional rake.

Another object of the present invention is to provide a self-cleaning rake device comprising a cleaning bar that can be moved along the tines to dislodge debris thereon.

Yet another object of the present invention is to provide a self-cleaning rake device having a cleaning bar for dislodging debris that can be easily actuated by means of a grip disposed on the shaft of the rake.

Yet another object of the present invention is to provide a self-cleaning rake device having a cleaning bar that is attached to a spring-loaded extension rod that automatically retracts once extended.

Another object of the present invention is to provide a self-cleaning rake that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of the self-cleaning rake wherein the cleaning bar is in a retracted position.

FIG. 1B shows a perspective view of the self-cleaning rake of the present invention wherein the cleaning bar is in an extended position.

FIG. 2 shows a close-up view of the shaft of the self-cleaning rake of the present invention.

FIG. 3 shows a view of the extension rod and spring of the self-cleaning rake of the present invention.

FIG. 4 shows a close-up view of the cleaning bar of the present invention.

### DETAILED DESCRIPTION OF THE INVENTION

Reference is made herein to the attached drawings. Like reference numerals are used throughout the drawings to depict like or similar elements of the self-cleaning rake of the present invention. For the purposes of presenting a brief and clear description of the present invention, the preferred embodiment will be discussed as used for cleaning debris from the tines of a rake. The figures are intended for representative purposes only and should not be considered to be limiting in any respect.

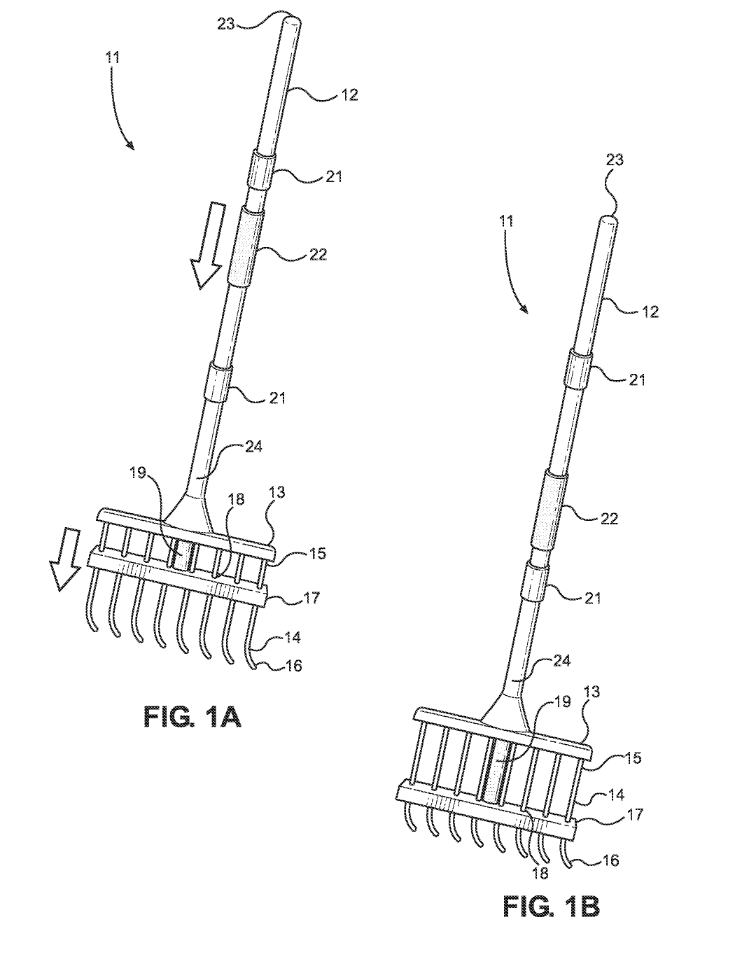

Referring now to FIGS. 1A and 1B, there are shown views of the self-cleaning rake of the present invention wherein the cleaning bar is in a retracted and extended position, respectively. The self-cleaning rake 11 comprises an elongated shaft 12 having a first end 23 and a second end 24. The elongated shaft 12 includes a hollow interior volume, and preferably comprises a circular cross section.

A rake head 13 is disposed on the second end 24 of the elongated shaft 12. The rake head 13 includes an elongated end having a plurality of tines 14 extending therefrom. The tines 14 are disposed perpendicularly to the elongated end of the rake head 13. The tines 14 are preferably elongated and are spaced at a fixed interval. Further, the tines 14 are substantially parallel to one another. The first end 15 of the tines 14 is attached to the rake head 13 and the second end 16 of the tines 14 extends outward therefrom. The second end 16 may be bent or curved to facilitate collecting leaves and debris on the ground.

A cleaning bar 17 is disposed on the tines 14 and is adapted to move along the tines 14 from a retracted position wherein the cleaning bar 17 is near the first end 15 of the tines 14 to an extended configuration wherein the cleaning bar 17 is near the second end 16 thereof. The cleaning bar 17 includes openings 18 adapted to receive each tine 14 of the self-cleaning rake 11 therethrough. The cleaning bar 17 is disposed substantially perpendicularly to the tines 14 and is parallel to the elongated end of the rake head 13 such that it can be positioned flush thereagainst when in a retracted configuration.

The cleaning bar 17 is connected to an extension rod 19. The first end of the extension rod 19 is preferably connected to a central portion of the cleaning bar 17 and extends through the rake head 13. As such, the first end of the extension rod 19 is disposed between the tines 14 that are located in the middle portion of the rake head 13. The second end of the extension rod 19 extends through the interior of the elongated shaft 12. The second end of the extension rod 19 is connected to a slidable grip 22 disposed on the exterior of the elongated shaft 12. The grip 22 is substantially cylindrical and is adapted to slide along the length of the elongated shaft 12. In this way the slidable grip 22 can be used to actuate the cleaning bar 17 so as to move the cleaning bar 17 along the length of the tines 14. In operation, a user can easily move the grip 22 along the elongated shaft 12 in order to dislodge leaves and other debris on the tines 14. Thus, the user does not need to remove the debris by hand or use another tool.

The elongated shaft 12 further includes one or more stoppers 21 thereon. The stoppers 21 are cylindrical and are fixed on the elongated shaft 12. The stoppers 21 serve to constrain the motion of the slidable grip 22. When the slidable grip 22 is moved towards the rake head 13, the slidable grip 22 contacts a first stopper 21, preventing the slidable grip 22 from moving further down the elongated shaft 12. Similarly, in the retracted position, the slidable grip 22 may be positioned against a second stopper 21, preventing the slidable grip 22 from moving further along the elongated shaft 12.

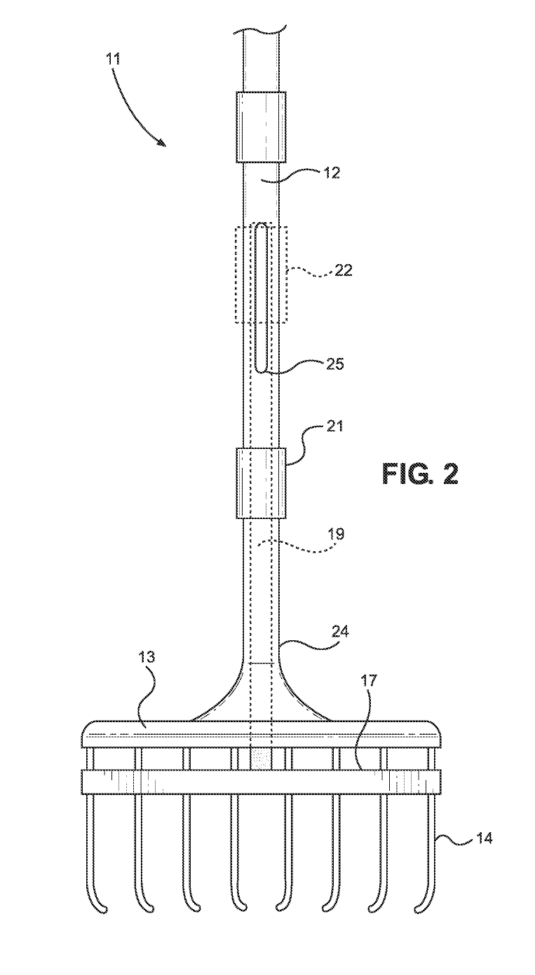

Referring now to FIG. 2, there is shown a view of the elongated shaft of the self-cleaning rake of the present invention. The elongated shaft 12 is tubular and comprises a hollow interior. A mid-portion of the shaft 12 includes a channel 25 thereon, over which the grip 22 is positioned. The first end of the extension rod 19 extends from the cleaning bar 17 through the rake head 13 and into the elongated shaft 12. A portion of the second end of the extension rod 19 extends through the channel 25 and is connected to the grip 22. In this way, the grip 22 can slide along the exterior of the shaft 12 from a first end of the channel 25 to the second end thereof. Thus, the channel 25 restricts the degree to which the grip 22 can slide, which restricts the movement of the cleaning bar 17 on the tines 14. This prevents the cleaning bar 17 from sliding off of the second end of the tines 14.

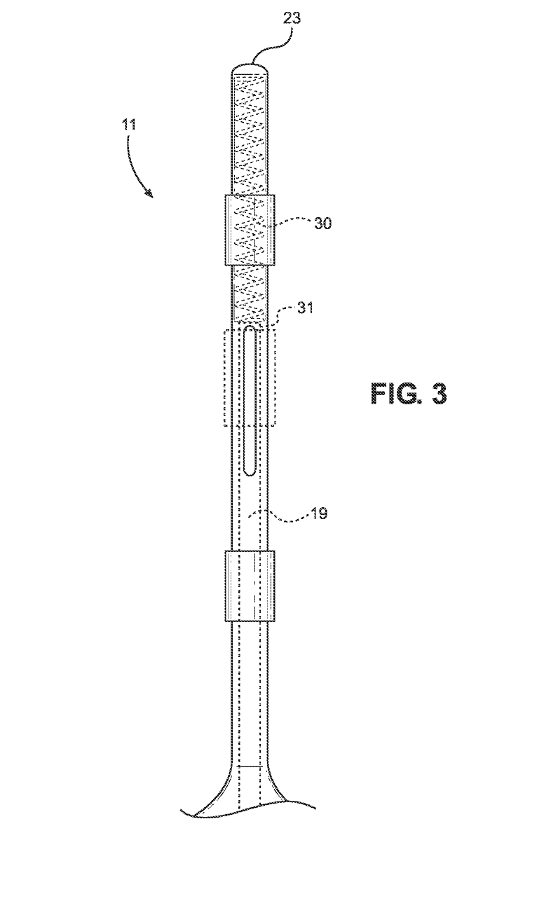

Referring now to FIG. 3, there is shown a view of an embodiment of the extension rod and spring of the self-cleaning rake. In some embodiments of the present invention, the extension rod 19 is spring-loaded. A spring 30 is positioned within the elongated shaft 12 and includes a first end affixed to the first end 23 of the elongated shaft 12, and a second end affixed to an end 31 of the extension rod 19. In a resting or retracted position, the cleaning bar 17 is positioned against the rake head 13 on the first end of the tines so that the rake 11 can be used in the conventional fashion. When the grip 22 is actuated by the user, and moved along the shaft 12 towards the rake head 13, the extension rod 19 within the shaft 12 moves towards the rake head 13, causing the cleaning bar 17 to move from the first end of the tines towards the second end thereof. The cleaning bar 17 dislodges any debris stuck between the tines as the cleaning bar 17 moves towards the second end of the tines. As this occurs, the spring 30 within the elongated shaft 12 is stretched and is under tension. Thus, the spring 30 will cause the extension rod 19 and the cleaning bar 17 attached thereto to return to the resting position once the user ceases to push the grip 22 towards the rake head 13. This eliminates the need for the user to move the grip 22 back and forth each time the user wishes to remove debris from the tines. The spring-loaded extension rod 19 also prevents the cleaning bar 17 from sliding towards the second end of the tines while the rake 11 is in use, and maintains the cleaning bar 17 in a retracted position.

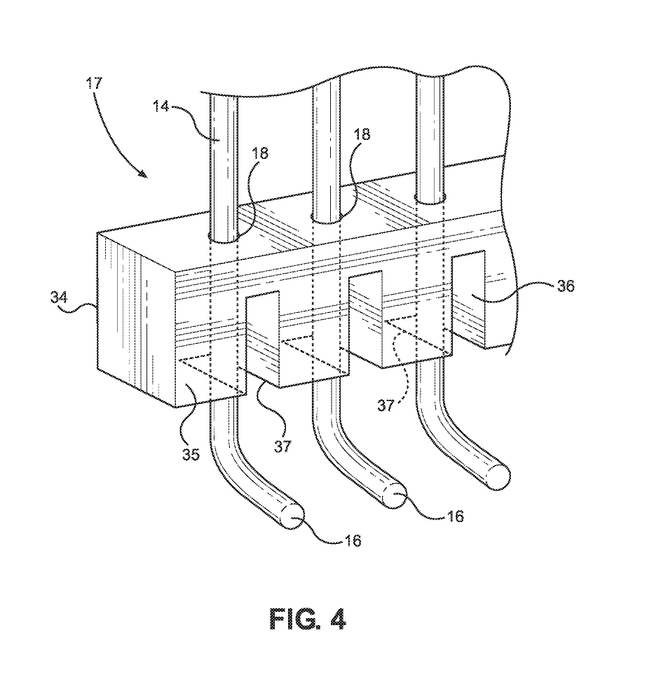

Referring now to FIG. 4, there is shown a close-up view of the cleaning bar of the present invention. The cleaning bar 17 preferably comprises an elongated rectangular shape. The cleaning bar 17 includes an upper end, a lower end, and a first side 34 opposite a second side 35. The upper end includes a plurality of openings 18 thereon, through which the tines 14 extend. The cleaning bar 17 includes a plurality of channels thereon, wherein each channel is adapted to receive a tine 14 therethrough. The lower end of the cleaning bar includes rectangular openings 37 thereon through which the tines 14 can be inserted. Thus, each tine 14 extends through the opening 18 on the upper surface and through the rectangular opening 37 on the lower end of the cleaning bar 17. The rectangular openings 37 extend from the second side 35 towards the first side 34 of the cleaning bar 17. Further, the second side 35 of the cleaning bar 17 includes rectangular openings 36 thereon. The rectangular openings 36 extend from the lower end towards the upper end of the cleaning bar 17. In this way, as the cleaning bar 17 reaches the curved end of the tines 14, the curved end 16 of the tines can extend through the rectangular openings 36, 37 on the lower end and second side of the cleaning bar. This allows the entirety of the tines 14 to be cleaned, including the curved portion thereof.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A self-cleaning rake, comprising:
an elongated shaft having a first end and a second end;
a rake head affixed to said second end;
wherein said rake head comprises a plurality of elongated tines extending therefrom;
a cleaning bar slidably disposed on said plurality of elongated tines;
an extension rod having a first end and a second end, wherein said first end is secured to said cleaning bar, wherein said extension rod extends through said rake head and through an interior of said elongated shaft;
a grip slidably disposed on an exterior of said elongated shaft and connected to said second end of said extension rod such that said grip is adapted to control the movement of said cleaning rod along said plurality of elongated tines.

2. The self-cleaning rake of claim 1, wherein said plurality of elongated tines are substantially parallel to one another.

3. The self-cleaning rake of claim 1, wherein said plurality of elongated tines are spaced at a fixed interval.

4. The self-cleaning rake of claim 1, wherein said plurality of elongated tines comprise a first end and a second end, wherein said first end is attached to said rake head, and wherein said second end is bent.

5. The self-cleaning rake of claim 1, wherein said elongated shaft is of a hollow, tubular construction.

6. The self-cleaning rake of claim 1, wherein said elongated shaft comprises stoppers thereon adapted to restrict the movement of said grip.

7. The self-cleaning rake of claim 1, wherein a channel is positioned on said elongated shaft, wherein said grip is connected to said extension rod through said channel.

8. The self-cleaning rake of claim 1, wherein said extension rod is spring loaded such that said cleaning bar is positioned against said rake head in a retracted configuration, and wherein said cleaning bar is under tension when in an extended configuration.

9. The self-cleaning rake of claim 8, further comprising a spring having a first end and a second end, wherein said first end of said spring is connected to said first end of said elongated shaft, and wherein said second end of said spring is connected to said second end of said extension rod.

10. The self-cleaning rake of claim 1, wherein said cleaning bar comprises an elongated rectangular configuration.

11. The self-cleaning rake of claim 10, wherein said cleaning bar further comprises openings on an upper end thereof through which said plurality of tines can extend, and further comprising a plurality of channels on a lower end of said cleaning bar.
